(19) United States
(12) Patent Application Publication
(10) Pub. No.: US 2026/0011245 A1
(43) Pub. Date: Jan. 8, 2026

(54) METHOD FOR ASCERTAINING A TURN PROBABILITY

(71) Applicant: Robert Bosch GmbH, Stuttgart (DE)

(72) Inventors: Christian-Eike Framing, Ludwigsburg (DE); Stefan Werder, Hannover (DE)

(21) Appl. No.: 19/246,784

(22) Filed: Jun. 24, 2025

(30) Foreign Application Priority Data
Jul. 2, 2024 (DE) 10 2024 206 168.9

(51) Int. Cl. G08G 1/16; G01C 21/00

(52) U.S. Cl. CPC G08G 1/16; G01C 21/3819

(57) ABSTRACT

A method for ascertaining a turn probability that a motor vehicle will leave a road junction, in particular a roundabout, including a plurality of exits and one or more entrances, at an exit of the road junction. The method includes: receiving trajectory data comprising a plurality of trajectories of motor vehicles crossing the road junction; ascertaining trajectories of motor vehicles passing the one exit from the plurality of trajectories, wherein passing includes leaving or driving past the one exit; classifying the ascertained trajectories based on a particular previous route of the motor vehicles corresponding to the ascertained trajectories before the one exit to obtain a plurality of trajectory classes, each of which includes ascertained trajectories having the same previous route; ascertaining, for each trajectory class, a particular turn probability that a motor vehicle will leave the road junction at the one exit, based on the respectively ascertained trajectories.

### CROSS REFERENCE

The present application claims the benefit under 35 U.S.C. § 119 of German Patent Application No. DE 102024 206 168.9 filed on July 2, 2024, which is expressly incorporated herein by reference in its entirety.

### FIELD

The present invention relates to a method for ascertaining a turn probability that a motor vehicle will leave a road junction, in particular a roundabout, comprising a plurality of exits and one or more entrances, at an exit of the road junction, to a method for ascertaining a turn probability for a motor vehicle driving within a road junction, in particular a roundabout, comprising a plurality of exits and one or more entrances that the motor vehicle will leave the road junction at a next exit, to a device, to a computer program and to a machine-readable storage medium.

### BACKGROUND INFORMATION

A motor vehicle driving within a road junction, in particular a roundabout, comprising a plurality of exits, can leave it at one of the plurality of exits. For road users in the vicinity of the motor vehicle, knowing how likely it is whether the motor vehicle will leave the road junction at the next exit or not can be advantageous or helpful for their own decisions.

There is therefore a need for a concept for ascertaining a turn probability.

### SUMMARY

An object of the present invention is to provide a concept for ascertaining a turn probability.

This object may be achieves by means of certain features of the present invention. Advantageous embodiments of the present invention are disclosed herein.

According to a first aspect of the present invention, a method is provided for ascertaining a turn probability that a motor vehicle will leave a road junction, in particular a roundabout, comprising a plurality of exits and one or more entrances, at an exit of the road junction. According to an example embodiment of the present invention, the method includes the following steps: receiving trajectory data comprising a plurality of trajectories of motor vehicles crossing the road junction, ascertaining trajectories of motor vehicles passing the one exit from the plurality of trajectories, wherein passing comprises leaving or driving past the one exit, classifying the ascertained trajectories based on a particular previous route of the motor vehicles corresponding to the ascertained trajectories before the one exit in order to obtain a plurality of trajectory classes, each of which comprises ascertained trajectories having the same previous route, ascertaining, for each trajectory class, a particular turn probability that a motor vehicle will leave the road junction at the one exit, based on the respectively ascertained trajectories.

According to a second aspect of the present invention, a method is provided for ascertaining a turn probability for a motor vehicle driving within a road junction, in particular a roundabout, comprising a plurality of exits and one or more entrances that the motor vehicle will leave the road junction at a next exit. According to an example embodiment of the present invention, the method includes the following steps: ascertaining a previous route of the motor vehicle before the one next exit, assigning the ascertained previous route of the motor vehicle to one of a plurality of previous routes corresponding to classified trajectory classes, wherein each trajectory class is assigned a particular turn probability that a motor vehicle will leave the road junction at the one next exit, ascertaining the turn probability based on the turn probability of the trajectory class to which the ascertained previous route of the motor vehicle was assigned.

According to a third aspect of the present invention, a device, in particular a driver assistance system, is provided that is configured to perform all steps of the method according to the first aspect of the present invention and/or according to the second aspect of the present invention.

According to a fourth aspect of the present invention, a computer program is provided, comprising commands that, when the computer program is executed by a computer, for example by the device according to the third aspect of the present invention, cause said computer to perform a method according to the first aspect of the present invention and/or according to the second aspect of the present invention.

According to a fifth aspect of the present invention, a machine- readable storage medium is provided, on which the computer program according to the fourth aspect of the present invention is stored.

The present invention is based on and includes the finding that the above object may be achieved by taking into account the previous route of a motor vehicle in order to ascertain a probability that the motor vehicle will leave the road junction at an exit thereof. If this is carried out for a plurality of motor vehicles, a turn probability can be statistically assigned to each exit of the road junction for each trajectory class, so that this knowledge can then be used to make a statement for an individual motor vehicle traveling within the road junction about how likely it is that the motor vehicle will leave the road junction at the next exit. For this purpose, the previous route of the individual motor vehicle is ascertained, which is then assigned to the previously ascertained trajectory classes, so that the turn probability corresponding to the assigned trajectory class is then used to make the statement described above. For example, it is determined that the turn probability of the individual motor vehicle corresponds to the turn probability of the trajectory class to which the previous route of the individual motor vehicle was assigned.

Thus, the turn probability can be advantageously ascertained efficiently. Furthermore, knowledge can therefore be made available efficiently, based on which a driver assistance system can make decisions in the context of a driver assistance function. For example, future behavior of the individual motor vehicle can be ascertained, in particular predicted.

For example, a road junction is an element selected from the following group of road junctions: roundabout, intersection, T- intersection, highway interchange, highway directional interchange.

For example, a road junction includes one or more entrances.

For example, a road junction includes a plurality of exits.

In one example embodiment of the method according to the first aspect of the present invention, it is provided that the road junction comprises a plurality of entrances, wherein it is determined that the previous route leads past a certain number of entrances.

This results in the technical advantage, for example, that different routes can be distinguished efficiently. The higher the certain number of entrances, the higher the probability that the previous routes are different. The certain number of entrances can also be referred to as search depth. For example, the search depth is 2. The entrances are in particular the last entrances before the one exit.

In one example embodiment of the method according to the first aspect of the present invention, it is provided that, for the ascertained trajectories, it is ascertained from which direction the corresponding motor vehicle entered which entrance into the road junction, wherein the ascertained trajectories are classified based on the ascertained directions, so that, for the plurality of trajectory classes, the motor vehicles corresponding to the ascertained routes entered the same entrance from the same direction into the road junction.

This, for example, results in the technical advantage that the classification can be performed efficiently. This results in the technical advantage, for example, that different routes can be distinguished efficiently.

In one example embodiment of the method according to the first aspect of the present invention, it is provided that the ascertained turn probabilities are compared with one another in pairs, wherein, based on the comparisons, the corresponding trajectory classes are merged to obtain a merged trajectory class that comprises the ascertained trajectories of the corresponding trajectory classes, wherein, for the merged trajectory class, a turn probability is ascertained that a motor vehicle will leave the road junction at the one exit, based on the turn probabilities respectively ascertained for the corresponding trajectory classes.

This results in the technical advantage, for example, that the search depth can initially be large, for example greater than 2, wherein, if the turn probabilities are similar, not every trajectory class is kept separately, but only the merged trajectory class, which can efficiently reduce memory requirements. In particular, when the turn probabilities are inserted into a digital map comprising the road junction, merging reduces the size of the digital map compared to a digital map to which both trajectory classes have been added.

For example, it is determined that two trajectory classes are merged if a result of the comparison is less than or equal to a predetermined threshold.

In one example embodiment of the method according to the first aspect of the present invention, it is provided that an average value of the respectively ascertained turn probabilities is ascertained as the turn probability of the merged trajectory class.

This results in the technical advantage, for example, that the turn probability can be ascertained efficiently for the merged trajectory class.

In one example embodiment of the method according to the first aspect of the present invention, it is provided that ascertained turn probabilities having associated trajectory classes are added to a digital map, in particular a topological map, comprising the road junction.

This results in the technical advantage, for example, of creating a digital map on the basis of which motor vehicles, in particular at least partially automated motor vehicles, can navigate efficiently. In particular, based on such a map, a driver assistance system of the motor vehicle can perform a driver assistance function, for example a trajectory planning or a warning of a dangerous traffic situation.

In one example embodiment of the method according to the first aspect of the present invention, it is provided that a particular speed profile and/or a particular acceleration profile of the corresponding motor vehicles before the one exit is ascertained based on the respective ascertained trajectories, wherein the particular turn probability is ascertained based on the respective speed profiles and/or the respective acceleration profiles.

This results in the technical advantage, for example, that the particular turn probability can be ascertained efficiently. As a rule, a speed of the turning vehicle decreases before turning, which is also reflected in an acceleration profile. By evaluating such profiles, it can be efficiently ascertained whether the vehicle will turn or not.

In one example embodiment of the method according to the second aspect of the present invention, it is provided that a speed profile and/or an acceleration profile of the motor vehicle is ascertained before the one next exit, wherein the turn probability is ascertained based on the ascertained speed profile and/or the ascertained acceleration profile.

This results in the technical advantage, for example, that the turn probability can be ascertained efficiently. As a rule, a speed of the turning vehicle decreases before turning, which is also reflected in an acceleration profile. By evaluating such profiles, it can be efficiently ascertained whether the vehicle will turn or not.

In one example embodiment of the method according to the second aspect of the present invention, it is provided that the method steps are carried out by means of a driver assistance system of the one motor vehicle or of another motor vehicle located in the vicinity of the one motor vehicle, wherein a future behavior of the one motor vehicle is ascertained by means of the driver assistance system based on the ascertained turn probability, wherein a driver assistance function, in particular a trajectory planning or a warning of a dangerous traffic situation, is carried out by means of the driver assistance system based on the ascertained future behavior.

This, for example, results in the technical advantage that the method can be implemented efficiently. In particular, this results in the technical advantage that the motor vehicle can be operated safely.

In one example embodiment of the method according to the second aspect of the present invention, it is provided that the step of assigning the ascertained previous route of the motor vehicle to one of a plurality of previous routes corresponding to classified trajectory classes, based on a digital map, in particular a topological map, comprising the road junction, which map comprises turn probabilities assigned to the road junction having associated trajectory classes, is carried out by using the trajectory classes with assigned turn probabilities of the digital map as those trajectory classes to which the ascertained previous route is to be assigned. The digital map is, for example, the digital map according to an embodiment of the method according to the first aspect.

The device of the present invention is, for example, configured in terms of program technology to execute the computer program.

The method according to the first aspect of the present invention is, for example, a computer-implemented method.

The method according to the second aspect of the present invention is, for example, a computer-implemented method.

Features of the method according to the first aspect of the present invention result analogously from features of the method according to the second aspect of the present invention, and vice versa.

The particular turn probability assigned to the trajectory classes according to the method according to the second aspect was ascertained, for example, by means of the method according to the first aspect of the present invention.

Device features result analogously from method features, and vice versa.

The embodiments and exemplary embodiments described here can be combined with one another in any way even if this is not explicitly described.

For example, it is provided that after the trajectory classes are merged, the original trajectory classes are deleted. Thus, for example, it is provided that only the merged trajectory class having the associated or assigned turn probability is added to the digital map.

A trajectory in the sense of the description is, for example, a sequence of points that have a position and a timestamp.

A route in the sense of the description is in particular a sequence of traversed lanes or road sections, which comprises the selected entrances at road junctions.

A digital map in the sense of the description is, for example, a digital road map.

The turn probability at an exit can, for example, be ascertained based on the trajectories using the proportion of motor vehicles turning at the one exit compared to the total number of motor vehicles passing through the one exit.

The term "at least partially automated" includes the following: partially automated, highly automated, fully automated and autonomous.

The present invention is explained in more detail below using preferred exemplary embodiments.

### BRIEF DESCRIPTION OF THE DRAWINGS

FIG. 1 shows a flowchart of an example method according to the first aspect of the present invention.

FIG. 2 shows a flowchart of an example method according to the second aspect of the present invention.

FIG. 3 shows a device according to an example embodiment of the present invention.

FIG. 4 shows a machine-readable storage medium according to an example embodiment of the present invention.

FIG. 5 to FIG. 8 each show the same road junction with different trajectory classes, according to an example embodiment of the present invention.

FIG. 9 shows a merging of two trajectory classes, according to an example embodiment of the present invention.

In the following, the same reference signs can be used for identical features.

### DETAILED DESCRIPTION OF EXAMPLE EMBODIMENTS

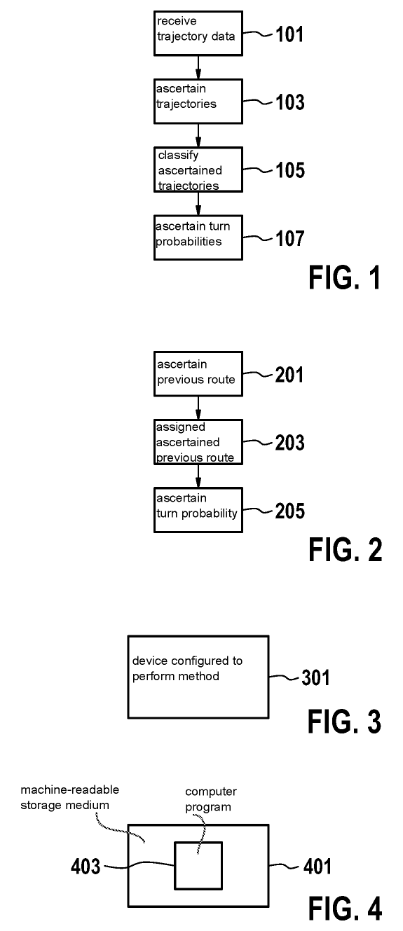

FIG. 1 shows a flowchart of a method for ascertaining a turn probability that a motor vehicle will leave a road junction, in particular a roundabout, comprising a plurality of exits and one or more entrances, at an exit of the road junction, the method comprising the following steps: receiving 101 trajectory data comprising a plurality of trajectories of motor vehicles crossing the road junction, ascertaining 103 trajectories of motor vehicles passing the one exit from the plurality of trajectories, wherein passing comprises leaving or driving past the one exit, classifying 105 the ascertained trajectories based on a particular previous route of the motor vehicles corresponding to the ascertained trajectories before the one exit in order to obtain a plurality of trajectory classes, each of which comprises ascertained trajectories having the same previous route, ascertaining 107, for each trajectory class, a particular turn probability that a motor vehicle will leave the road junction at the one exit, based on the respectively ascertained trajectories.

FIG. 2 shows a flowchart of a method for ascertaining a turn probability for a motor vehicle driving within a road junction, in particular a roundabout, comprising a plurality of exits and one or more entrances that the motor vehicle will leave the road junction at a next exit, the method comprising the following steps: ascertaining 201 a previous route of the motor vehicle before the one next exit, assigning 203 the ascertained previous route of the motor vehicle to one of a plurality of previous routes corresponding to classified trajectory classes, wherein each trajectory class is assigned a particular turn probability that a motor vehicle will leave the road junction at the one next exit, ascertaining 205 the turn probability based on the turn probability of the trajectory class to which the ascertained previous route of the motor vehicle was assigned.

FIG. 3 shows a device 301 configured to perform all steps of the method according to the first aspect and/or according to the second aspect.

The device 301 is, for example, a driver assistance system or is, for example, implemented in a driver assistance system.

FIG. 4 shows a machine-readable storage medium 401, on which a computer program 403 is stored. The computer program comprises commands that, when the computer program is executed by a computer, cause said computer to carry out a method according to the first aspect and/or according to the second aspect.

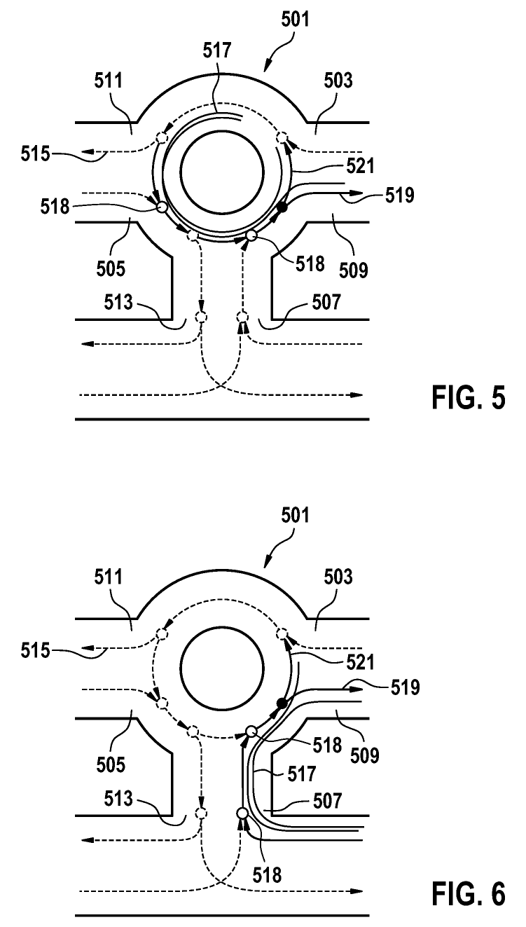

FIG. 5 shows a roundabout 501 as an example of a road junction.

The roundabout 501 comprises a first entrance 503, a second entrance 505 and a third entrance 507. The roundabout 501 comprises a first exit 509, a second exit 511 and a third exit 513.

The topology from a digital map, which comprises the roundabout 501, is shown in dashed lines in FIG. 5 with the reference sign 515.

A digital map in the sense of the description is, for example, a digital road map. The topology therein describes the linking and the sequence of the lanes, in particular also such linkings that represent a merge point or a split point of consecutive lanes.

The above statements in connection with FIG. 5 apply analogously to FIG. 6 to 9, which show the same roundabout 501.

According to the concept described here, a turn probability is ascertained for the first exit 509 that a motor vehicle will leave the roundabout 501 at this exit. According to the concept described here, the previous route of the motor vehicles is taken into account when ascertaining this turn probability. The individual trajectories are therefore classified according to their previous route.

In the representations according to FIG. 5 to 8, trajectory classes are defined based on the sequence of their past merge transitions. Every point in the topology represented by the dashed arrows 515, at which two arrows 515 combine into one, is a merge point, briefly referred to as a "merge." A motor vehicle passing this point from a given direction performs a merge transition. The trajectories with reference signs 517, drawn with solid lines in the figures, have therefore already performed two merge transitions before reaching the first exit 509.

In FIG. 5 to 9, the merge points relevant to the particular trajectory classification are marked with the reference sign 518.

This abstract description of the previous route has the advantage that it does not require any knowledge about whether the traffic area is, for example, an intersection or a roundabout and where the entrances into the roundabout 501 considered here are located.

It is noted that the entrances 503,505 and 507 into the roundabout 501 can be used here as a substitute for illustrative and exemplary distinguishing features of the trajectory classes in FIG. 5 to 8. It is further noted that the trajectory classes of different entrances into the roundabout 501 up to the exit 509 actually already have different numbers of merge transitions (different search depths).

In the representation according to FIG. 5, it is provided that a trajectory class is defined that contains trajectories 517 of which associated motor vehicles have entered the roundabout 501 at the first entrance 503.

At the first exit 509, the motor vehicles pass this exit. This means that the motor vehicles can leave the roundabout 501 at the first exit 509, which is indicated by an arrow with the reference sign 519. This means that the motor vehicles pass the first exit 509, which is represented by an arrow with the reference sign 521.

Based on the trajectories 517, a turn probability is ascertained for the first exit 509 and this ascertained turn probability is assigned to the trajectory class described above.

The turn probability at an exit can, for example, be ascertained based on the trajectories using the proportion of motor vehicles turning at the one exit compared to the total number of motor vehicles passing through the one exit.

A trajectory classification takes place analogously in FIG. 6 to 8. According to FIG. 6, trajectories are considered of which associated motor vehicles entered the roundabout 501 at the third entrance 507 from the right direction relative to the plane of the paper.

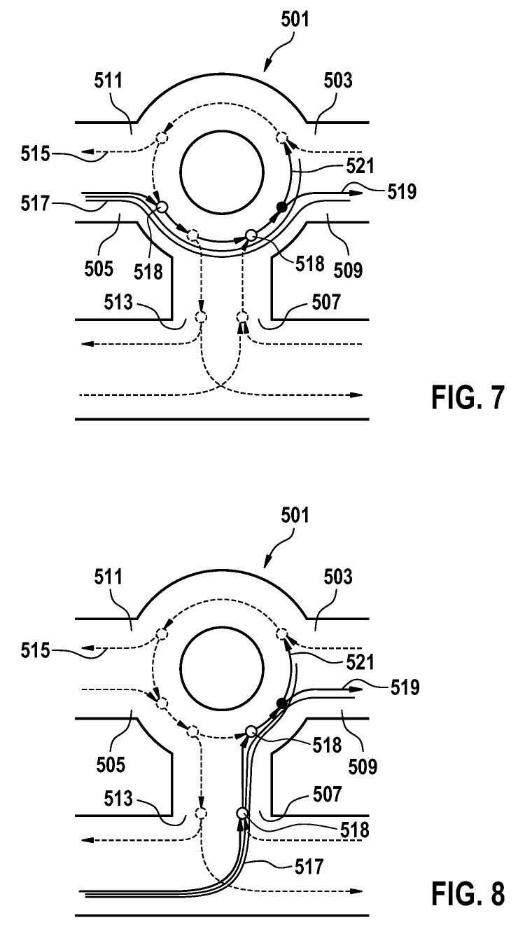

According to FIG. 7, trajectories are considered with regard to the turn probability of which associated motor vehicles entered the roundabout 501 at the second entrance 505.

According to FIG. 8, with regard to the turn probability at the first exit 509, only those trajectories are considered of which associated motor vehicles entered the roundabout 501 at the third entrance 507 from the left direction with respect to the plane of the paper.

Thus, a classification of the trajectories takes place with regard to the previous routes of the motor vehicles in relation to the first exit 509. For each of these trajectory classes, a corresponding turn probability is ascertained and assigned to this trajectory class.

For example, it is provided that the trajectory classes having the associated turn probability will be added to the digital map that comprises the roundabout 501.

For example, it is provided that in one embodiment of the method according to the second aspect, a previous route of a motor vehicle traveling within the roundabout 501 is ascertained in order to ascertain, based on the turn probabilities ascertained above, a turn probability that the motor vehicle will leave the roundabout 501 at the first exit 509.

Analogously, a corresponding trajectory classification with an ascertainment of a corresponding turn probability can also be carried out for the second exit 511 and for the third exit 513.

Thus, for each of the exits 509, 511, 513 of the roundabout 501, trajectory classes can be defined and a turn probability can be ascertained for each of these trajectory classes.

The same procedure can be used for the exits of the T- intersection shown (intersection below the roundabout 501). The concept is not fundamentally limited to roundabouts. It is merely particularly dependent on the ability to ascertain the previous route of a motor vehicle.

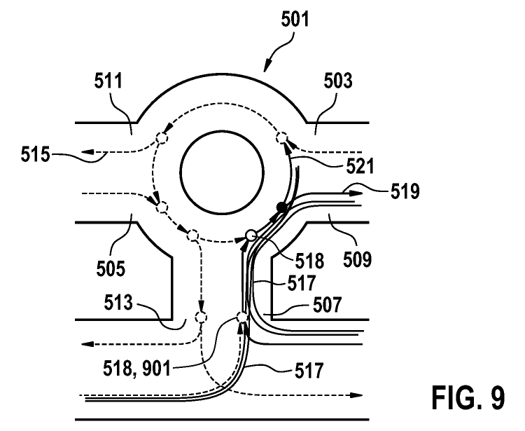

FIG. 9 shows a merging of two trajectory classes. As an example, the trajectory classes according to FIG. 6 and 8 were merged here. This can be carried out, for example, when the corresponding turn probabilities are very similar. Thus, for example, a comparison of these turn probabilities can be carried out. If the result of the comparison is less than or equal to a predetermined threshold, the trajectory classes are merged. A turn probability of the merged trajectory classes is, for example, an average value of the respective turn probabilities of the trajectory classes according to FIG. 6 and 8.

Consequently, in FIG. 9, one of the corresponding merge points 518 is no longer relevant for classification. This one merge point 518 is additionally marked with the reference sign 901.

The concept described here can be used, for example, to determine routes that have a high frequency of motor vehicles.

The information regarding the turn probability can, for example, be used to plan and construct traffic infrastructure. For example, it is provided that the turn probabilities ascertained within the framework of the concept described here are used to ascertain a signal timing plan of a light signal system, wherein the light signal system, for example, regulates traffic at the road junction.

What is claimed is:

1. A method for ascertaining a turn probability that a motor vehicle will leave a road junction including a roundabout, including a plurality of exits and one or more entrances, at a respective exit of the road junction, the method comprising the following steps:
receiving trajectory data including a plurality of trajectories of motor vehicles crossing the road junction;
ascertaining trajectories of corresponding motor vehicles passing the respective exit from the plurality of trajectories, wherein the passing includes leaving or driving past the respective exit;
classifying the ascertained trajectories based on a particular previous route of the motor vehicles corresponding to the ascertained trajectories before the respective exit to obtain a plurality of trajectory classes, each of the trajectory classes including ascertained trajectories having the same previous route; and
ascertaining, for each trajectory class of the trajectory classes, a respective turn probability that a motor vehicle will leave the road junction at the respective exit, based on the ascertained trajectories.

2. The method according to claim 1, wherein the road junction includes a plurality of entrances, and it is determined the previous route leads past a certain number of the entrances.

3. The method according to claim 1, wherein, for each of the ascertained trajectories, it is ascertained from which direction the corresponding motor vehicle entered which entrance into the road junction, wherein the ascertained trajectories are classified based on the ascertained directions, so that, for each of the plurality of trajectory classes, the motor vehicles corresponding to the ascertained routes entered the same entrance from the same direction into the road junction.

4. The method according to claim 1, wherein the ascertained turn probabilities are compared with one another in pairs, wherein, based on the comparisons, the trajectory classes corresponding to each ascertained probably pair are merged to obtain a merged trajectory class that includes the ascertained trajectories of the corresponding trajectory classes, wherein, for the merged trajectory class, a turn probability is ascertained that a motor vehicle will leave the road junction at the respective exit, based on the turn probabilities respectively ascertained for the corresponding trajectory classes.

5. The method according to claim 4, wherein an average value of the respectively ascertained turn probabilities is ascertained as the turn probability of the merged trajectory class.

6. The method according to claim 1,. ascertained turn probabilities having associated trajectory classes are added to a digital topological map which includes the road junction.

7. The method according to claim 1, wherein a particular speed profile and/or a particular acceleration profile of the corresponding motor vehicles before the respective exit ascertained based on the respective ascertained trajectories, wherein the respective turn probability is ascertained based on the respective speed profiles and/or the respective acceleration profiles.

8. A method for ascertaining a turn probability for a motor vehicle driving within a road junction including a roundabout, including a plurality of exits and one or more entrances that the motor vehicle will leave the road junction at a next exit, the method comprising the following steps:
ascertaining a previous route of the motor vehicle before the next exit;
assigning the ascertained previous route of the motor vehicle to one of a plurality of previous routes corresponding to classified trajectory classes, wherein each trajectory class is assigned a particular turn probability that a motor vehicle will leave the road junction at the next exit; and
ascertaining the turn probability based on the turn probability of the trajectory class to which the ascertained previous route of the motor vehicle was assigned.

9. The method according to claim 8, wherein a speed profile and/or an acceleration profile of the motor vehicle is ascertained before the next exit, wherein the turn probability is ascertained based on the ascertained speed profile and/or the ascertained acceleration profile.

10. The method according to claim 8, wherein the method steps are carried out by a driver assistance system of the motor vehicle or of another motor vehicle located in a vicinity of the one motor vehicle, wherein a future behavior of the motor vehicle is ascertained using the driver assistance system based on the ascertained turn probability, wherein a driver assistance function, including a trajectory planning or a warning of a dangerous traffic situation, is performed using the driver assistance system based on the ascertained future behavior.

11. A device configured to ascertain a turn probability that a motor vehicle will leave a road junction including a roundabout, including a plurality of exits and one or more entrances, at a respective exit of the road junction, the device configured to perform the following steps:
receiving trajectory data including a plurality of trajectories of motor vehicles crossing the road junction;
ascertaining trajectories of corresponding motor vehicles passing the respective exit from the plurality of trajectories, wherein the passing includes leaving or driving past the respective exit;
classifying the ascertained trajectories based on a particular previous route of the motor vehicles corresponding to the ascertained trajectories before the respective exit to obtain a plurality of trajectory classes, each of the trajectory classes including ascertained trajectories having the same previous route; and
ascertaining, for each trajectory class of the trajectory classes, a respective turn probability that a motor vehicle will leave the road junction at the respective exit, based on the ascertained trajectories.

12. A non-transitory machine-readable storage medium on which is stored a computer program including commands for ascertaining a turn probability that a motor vehicle will leave a road junction including a roundabout, including a plurality of exits and one or more entrances, at a respective exit of the road junction, the commands, when executed by a computer, causing the computer to perform the following steps:
receiving trajectory data including a plurality of trajectories of motor vehicles crossing the road junction;
ascertaining trajectories of corresponding motor vehicles passing the respective exit from the plurality of trajectories, wherein the passing includes leaving or driving past the respective exit;
classifying the ascertained trajectories based on a particular previous route of the motor vehicles corresponding to the ascertained trajectories before the respective exit to obtain a plurality of trajectory classes, each of the trajectory classes including ascertained trajectories having the same previous route; and
ascertaining, for each trajectory class of the trajectory classes, a respective turn probability that a motor vehicle will leave the road junction at the respective exit, based on the ascertained trajectories.
